(19) United States
(12) Patent Application Publication
(10) Pub. No.: US 2010/0092279 A1
(43) Pub. Date: Apr. 15, 2010

(54) SEALING MEANS BETWEEN ROTOR AND HOUSING IN A WATER TURBINE

(75) Inventors: Alain Demers, Montreal (CA); Anders Wedmark, Fjerdingby (NO)

Correspondence Address: NIXON & VANDERHYE, PC, 901 NORTH GLEBE ROAD, 11TH FLOOR, ARLINGTON, VA, 22203, US

(73) Assignee: ANDRITZ TECHNOLOGY AND ASSET MANAGEMENT GMBH, Graz (AU)

(21) Appl. No.: 12/307,323

(22) PCT Filed: Jun. 25, 2007
(86) PCT No.: PCT/NO2007/000230

§ 371 Date: Sep. 22, 2009

(30) Foreign Application Priority Data
Jul. 4, 2006 (NO) 20063088

(51) Int. Cl. F01D 11/08; F16J 15/44

(52) U.S. Cl. 415/173.3; 277/355

(57) ABSTRACT

A reaction water turbine including: a rotor having an axis of rotation and an radially outer surface; a housing surrounding the rotor and having a bearing support proximate to the radially outer surface of the rotor; and a seal mounted to the bearing support on the housing, the seal includes a brush seal extending to and bearing against the radially outer surface of the rotor.

This invention relates to a water turbine of the reaction type, such as a Francis or Kaplan turbine, comprising a rotor and a surrounding housing, with seal means between the rotor and the housing.

In this type of turbines there is a problem in that a large part the losses is connected with seal leakage. Today simple labyrinth seals are often used, but they require large clearances and so have large losses. In this connection the dimensions of the structures involved, are to be considered; and traditional axle seals are not of interest here.

U.S. Pat. No. 4,464,580 (Miller) is an example of a conventional hydro turbine provided with seals at locations corresponding to what is of interest to the present invention, i.e. at appreciable radial distances from the axis of the rotor. These known seals are lip seals.

U.S. Pat. No. 4,293,777 (Gamell) is directed to a very special type of turbine (“drag turbine”) provided with brush seals, these being a kind of axle seals subjected to low head pressures.

U.S. Pat. No. 6,406,027 (General Electric Company) describes brush seals in rotary machines, with an emphasis on steam and gas turbines, where the particular design and structure of the seals are at focus. Mainly axle seals are considered.

U.S. Pat. No. 6,913,265 (Datta) also relates to the design of a brush seal as such.

From the above it is apparent that brush seals are known in particular for use in gas turbines and the like.

On this background it is an important object of the present invention to provide a water turbine seal system that makes possible much smaller clearances than current labyrinth and other conventional seal designs for the purpose discussed above, so as to obtain an efficiency improvement in high head Francis turbines, inter alia.

This is obtained, according to the invention by providing in a water turbine as stated in the first paragraph above, sealing means comprising brush seals located at a radial distance from the rotor axis being a major proportion of the maximum radial dimension of the rotor. Thus, surprisingly brush seals have been found useful in clearances between the rotor and the housing in the types of water turbines being of interest here.

Advantages obtained with the solution according to the invention, are:
Smaller clearances
Substantially reduced leakage
Sealing less sensitive to vibrations that may occur
Increased efficiency both in new turbine units and retrofitted seals in existing units.

In the following description an example of a turbine design based on this invention will be explained more in detail, with reference to the drawing, where

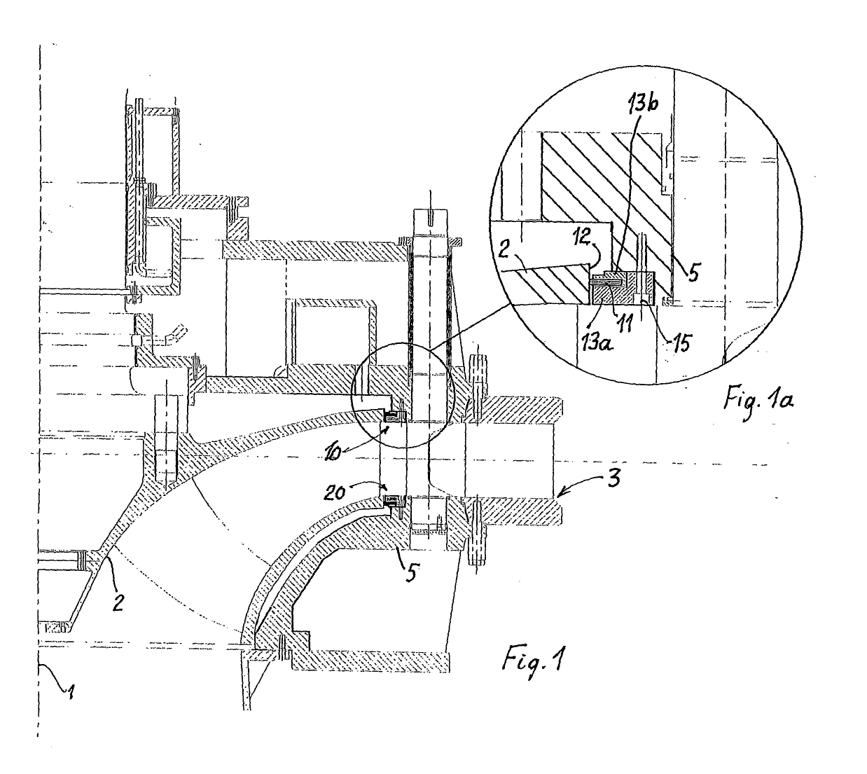

FIG. 1 in axial sectional view shows essential parts of a Francis turbine, and

FIG. 1a is an enlarged detail in the structure of FIG. 1.

As conventional the illustrated turbine comprises a rotor 2 having an axis of rotation 1, this axis being vertical in this example. Housing structure 5 surrounds the rotor and comprises a guide vane duct 5 for directing water towards the rotor 2. Leakage of this water in clearances between housing parts and closely adjacent portions of the rotor, should be prevented as much as possible. For this purpose there is provided for sealing as indicated at 10 and 20.

The seal 10 is shown more in detail in FIG. 1a. Seal 20 has a corresponding design. Thus, in FIG. 1a adjacent portions of the rotor 2 and the housing 5 are shaped so as to accommodate seal 10 in the form of a brush seal, the essential element of which is the actual brush or bristle assembly 11. This is mounted between clamp members 13a and 13b so as to have the projecting bristle ends bear against an outer end surface 12 facing radially outwards at the circumference of rotor 2. Advantageously, the brush or bristles in general form a right angle to surface 12, as seen in axial cross-section in FIGS. 1 and 1a. In the circumferential direction, however, the bristles will be oriented with an inclination to surface 12 corresponding to the direction of rotation. In addition some bending will normally be present towards the ends being applied against surface 12.

The location of the brush seals 10 and 20 should be noted, since according to the invention and in particular with turbines having a vertical axis of rotation, both seals 10 and 20 have positions approximately at the same radial distance from the axis 1. In this respect, however, modifications as to the radial position of upper (10) and lower (20) seals may vary according to the turbine design concerned. Although in many designs seal positions at approximately the same and/or maximum radial distance from the axis, would be preferred, other options are possible. What is important is that the radial distances of the seals from the axis, are a major proportion of the maximum radial dimension of the rotor. This shows that what is here of interest, has nothing to do with traditional axle sealing.

1-4. (canceled)

5. A reaction water turbine comprising:
a rotor having an axis of rotation and an radially outer surface;
a housing for the rotor and having a seal support proximate to the radially outer surface of the rotor;
a seal mounted to the seal support on the housing, said seal includes a brush seal extending to and bearing against the radially outer surface of the rotor.

6. The reaction water turbine of claim 5 wherein the turbine is a Francis or Kaplan type water turbine.

7. The reaction water turbine of claim 5 wherein the radially outer surface of the rotor is adjacent a water passage extending through the rotor.

8. The reaction water turbine of claim 5 wherein the brush seal includes bristles abutting against the radially outer surface of the rotor, wherein the radially outer surface extends circumferentially around the rotor axis and the bristles form an annulus extending around the radially outer surface.

9. The reaction water turbine of claim 5, wherein the brush seal extends substantially perpendicularly to the radially outer surface of the rotor.

10. The reaction water turbine of claim 5 wherein the axis of rotation is a vertical axis.

11. The reaction water turbine of claim 5 wherein the seal includes a first brush seal and a second brush seal arranged at substantially equal radial distances from the axis.

12. The reaction water turbine of claim 11 wherein the first brush seal is arranged adjacent a first side of an inlet to a water passage in the rotor and the second brush seal is arranged adjacent an second side, opposite to the first, of the inlet.

13. The reaction water turbine of claim 5 wherein the seal includes a clamp attached to the housing and holding the brush seal.

14. The reaction water turbine of claim 13 wherein the clamp includes a first clamp member and a second clamp member, and the brush seal is sandwiched between the first clamp member and the second clamp member.

15. The reaction water turbine of claim 5 wherein the brush seal extends annularly around the radially outer surface of the rotor.

16. The reaction water turbine of claim 15 wherein the brush seal includes a first annular brush seal and a second annular brush seal, wherein the first annular brush seal is adjacent a first side of a water passage extending through the rotor and the second annular brush seal is adjacent a second side, opposite to the first, of the water passage.

17. A seal for a reaction turbine having a rotor with a rotor axis and an outer periphery surrounded by a housing, the seal comprising:
a seal support fixed to the housing or the rotor, wherein the seal support secures an annular brush seal extending from the seal support, and
an annular bearing surface abutting the brush seal and opposite to the seal support, wherein the bearing surface is on an radially outer surface of the rotor or on a surface of the housing facing the radially outer surface of the rotor.

18. The seal of claim 17 wherein the brush seal includes flexible bristles arranged in an annulus extending circumferentially around the rotor axis.

19. The seal of claim 17 wherein the brush seal extends substantially perpendicularly to the bearing surface.

20. The seal of claim 17, wherein the seal includes a first brush seal and a second brush seal arranged at substantially equal radial distances from the axis.

21. The seal of claim 20 wherein the first brush seal is arranged adjacent a first side of a water passage in the rotor and the second brush seal is arranged adjacent an second side, opposite to the first, of the water passage.

22. The seal of claim 17 wherein the seal includes a clamp attached to the seal support surface and holds the brush seal.

23. The seal of claim 22 wherein the clamp sandwiches the brush seal between a first clamp member and a second clamp member included in the clamp.

24. The seal of claim 17 wherein the brush seal extends annularly around the radially outer surface of the rotor.

25. The seal of claim 24 wherein the brush seal includes a first annular brush seal and a second annular brush seal, wherein the first annular brush seal is adjacent a first side of a water passage extending through the rotor and the second annular brush seal is adjacent a second side, opposite to the first, of the water passage.
